(19) United States
(12) Patent Application Publication
(10) Pub. No.: US 2024/0175887 A1
(43) Pub. Date: May 30, 2024

(54) CONTROL DEVICE

(71) Applicant: UNISENSOR, Neupré (BE)

(72) Inventors: Benoît GRANIER, Ougrée (BE); Noan NIVARLET, Ougrée (BE); Simon DAUBE, Ougrée (BE); Julien STRAAT, Ougrée (BE)

(21) Appl. No.: 18/283,124

(22) PCT Filed: Mar. 21, 2022
(86) PCT No.: PCT/EP2022/057342

§ 371 Date: Sep. 20, 2023

(30) Foreign Application Priority Data
Mar. 22, 2021 (BE) 2021/5216
Mar. 22, 2021 (BE) 2021/5217
Mar. 22, 2021 (BE) 2021/5218

(51) Int. Cl. G01N 35/02; G01N 35/00; G01N 35/04

(52) U.S. Cl. CPC G01N 35/025; G01N 35/00584; G01N 35/026; G01N 2035/00346; G01N 2035/0418; G01N 2035/0444

(57) ABSTRACT

The present disclosure relates to a control device comprising a device site provided for placing a microfluidic device and rotating the microfluidic device about an axis, and a plurality of circumferentially distributed modules, such that a track of the microfluidic device passes from one module to another as a result of the microfluidic device rotating about the axis.

### CROSS-REFERENCE TO RELATED APPLICATION(S)

This present application is a national stage application of International Patent Application No. PCT/EP2022/057342, filed Mar. 21, 2022, which claims priority to Belgium Patent Application No. 2021/5216, filed Mar. 22, 2021, Belgium Patent Application No. 2021/5217, filed Mar. 22, 2021, and Belgium Patent Application No. 2021/5218, filed Mar. 22, 2021, the disclosures of which are hereby incorporated by reference in their entireties.

### TECHNICAL FIELD

The present disclosure relates in particular to a control device for controlling a microfluidic device and carrying out a detection on this microfluidic device.

### PRIOR ART

It is known from the prior art, for example WO2019/068806, to detect a component in a liquid by means of a permeable element. It is also known to integrate a permeable element into a microfluidic disc.

The document U.S. Ser. No. 10/406,528B1 describes a heating system for a centrifugal microfluidic device. This system allows a contact-free heating using an infrared emitter. A mask can be used to provide a selective heating of certain areas of the device.

The document DE102018212930B3 describes a system for detecting and heating a centrifugal microfluidic device and comprising a porous medium.

The document US2020070145A1 describes a system for detecting and heating a centrifugal microfluidic device.

### SUMMARY OF THE INVENTION

The disclosure proposes a control device comprising:
a device site provided for placing a microfluidic device and rotating the microfluidic device about an axis, and comprising:
a detection area,
a heating area;
a detection module comprising a detector designed to detect an electromagnetic radiation coming from the detection area; and
a heating module arranged to heat the heating area;
   the detection area being offset circumferentially from the heating area, so that at least one portion of the microfluidic device, for example a chamber, can be moved between the detection area and the heating area by rotation about the axis.

The control device according to the disclosure allows to accommodate a microfluidic device that can be oriented by rotation, and to carry out different actions on a portion of this microfluidic device depending on its orientation: if it is oriented according to a first orientation, a detection can be carried out, and if it is oriented according to a second orientation, a heating can be carried out. This also allows to heat and carry out a detection on circumferentially offset portions of the microfluidic device, for example on circumferentially offset microfluidic tracks.

The detection area is preferably aligned vertically, at least partially, with the detection module. The heating area is preferably aligned vertically, at least partially, with the heating module.

Optionally, the heating module comprises a plurality of heating elements located at different radial distances from the axis. This allows portions of the microfluidic device, for example different chambers, located at different radial distances, to be heated differently and/or specifically. When the microfluidic device comprises at least partially radial microfluidic tracks, it is thus possible to heat the different chambers of a microfluidic track with different intensities.

In one embodiment, the heating elements are circumferentially offset. In other words, at least two of the heating elements are circumferentially offset from each other. If the microfluidic device comprises circumferentially offset microfluidic tracks or chambers, this allows these circumferentially offset microfluidic tracks or chambers to be heated differently and/or specifically.

In one embodiment, the control device comprises a control unit configured to control the heating elements, preferably in groups and/or independently of one another. This allows you to choose which portions of the microfluidic device, for example which chambers, are heated. This allows different portions of the microfluidic device to be heated independently.

In one embodiment, the heating module allows an electromagnetic heating, preferably by radiation or induction.

In one embodiment, the detector comprises a camera. The camera is used to take images of a reading area of the microfluidic device (and therefore to read the permeable element), but also potentially of other portions of the microfluidic device.

According to an embodiment, the device site comprises a measurement area, the control device comprising a measurement module arranged to measure a parameter on the measurement area.

In one embodiment, the measurement area is offset circumferentially from the detection area and from the heating area.

According to another embodiment of the disclosure, the measurement area is located, at least in part, in the detection area and/or in the heating area.

In one embodiment, the parameter is a temperature.

According to one embodiment, the control device is arranged to control, at least in part, the heating module and/or the rotation of the microfluidic device as a function of the temperature measured by the measurement module. In this way, the temperature is regulated via a return loop. The heating can be adapted as a function of the measured temperature, for example by its location and/or its intensity and/or its duration, and/or the rotation can be adapted as a function of the measured temperature, for example to place a portion of the microfluidic disc in the heating area if its measured temperature is below a threshold.

In one embodiment, the measurement module comprises a plurality of measurement elements located at different radial distances from the axis. This allows to locate the temperature measured.

The disclosure further proposes a detection system comprising a control device, and a microfluidic device located at the device site and comprising a first microfluidic track; the detection area encompassing at least one portion of the first microfluidic track when the microfluidic device is oriented in a first orientation; and the heating area encompassing at least one portion of the first microfluidic track when the microfluidic device is oriented in a second orientation.

This allows to carry out a detection on the track in a first orientation and to heat it in a second.

According to an embodiment, the microfluidic device comprises a second track and the detection area encompasses at least one portion of the second microfluidic track when the microfluidic device is oriented in the second orientation. This allows to carry out a detection on the second track while the first track is heated.

In one embodiment, the measurement area encompasses at least one portion of the first microfluidic track when the microfluidic device is oriented in a third orientation. In this way, the temperature of the first track is measured in a third orientation.

The disclosure further proposes a method for using a detection system, in which at least one portion of the first microfluidic track, for example the detection chamber:
is in the heating area and is heated by the heating module,
passes, by rotation of the microfluidic device from the heating area to the detection area, and
is observed by the detector.

The method can be carried out with a microfluidic device having characteristics derived from any embodiment of the disclosure.

According to an embodiment, at least one portion of the first microfluidic track is in the heating area and is heated by the heating module while at least one portion of the second microfluidic track is in the detection area and is observed by the detector.

The disclosure further proposes a computer program comprising the instructions which drive a detection system to:
position at least one portion of the first microfluidic track, for example the detection chamber, in the heating area,
heat, by the heating module, the at least one portion of the first microfluidic track,
rotate the microfluidic device so as to position the at least one portion of the first microfluidic track in the detection area, and
observe, by the detector, the at least one portion of the first microfluidic track.

### BRIEF DESCRIPTION OF THE FIGURES

Further characteristics and advantages of the disclosure will become apparent from the following detailed description, for the understanding of which reference is made to the appended figures, among which:

FIG. 1a is a top view of a microfluidic device according to one embodiment of the disclosure, illustrating in particular microfluidic tracks,

FIG. 1b is a vertical cross-section along the line Ib in FIG. 1a,

FIG. 2 is a top view of any of the tracks of a microfluidic device according to one embodiment of the disclosure,

FIG. 3 is a vertical cross-sectional view illustrating a detection chamber according to one embodiment of the disclosure, allowing to illustrate in particular the first aspect of the disclosure,

FIG. 4 allows to illustrate, very schematically and in a horizontal view, elements of a control device according to one embodiment of the disclosure, it allows to illustrate in particular the second aspect of the disclosure,

FIG. 5 allows to illustrate, very schematically and vertically, elements of a control device and a microfluidic device according to one embodiment of the disclosure,

FIG. 6 illustrates, very schematically and in a horizontal view, modules of a control device according to one embodiment of the disclosure,

FIGS. 7a, 7b and 7c allow to illustrate, very schematically and in a horizontal view, the orientations of a microfluidic device according to one embodiment of the disclosure with respect to the modules shown in FIG. 6,

FIGS. 8a and 8b allow to illustrate, very schematically and in a horizontal view, elements of a microfluidic device according to one embodiment of the third aspect of the disclosure,

FIGS. 9a and 9b allow to illustrate, very schematically and in vertical cross-section, elements of a microfluidic device according to one embodiment of the third aspect of the disclosure,

FIG. 10 is a flow chart of a method according to the third aspect of the disclosure,

FIG. 11 illustrates, very schematically and in a horizontal view, elements of a microfluidic device according to one embodiment of the third aspect of the disclosure,

FIG. 12 allows to illustrate, very schematically and in a horizontal view, elements of a microfluidic device according to an embodiment of the third aspect of the disclosure, and

FIG. 13 is a flowchart of a method comprising characteristics resulting from the three aspects of the disclosure described below.

### EMBODIMENTS OF THE INVENTION

The present disclosure is described with particular embodiments and references to figures but the disclosure is not limited thereby. The drawings or figures described are only schematic and are not limiting. In addition, the functions described may be carried out by structures other than those described in this document.

In the context of this present document, the terms “first” and “second” are used only to differentiate the various elements and do not imply an order between these elements.

In the figures, the identical or similar elements may have the same references.

In the context of this document, an “analyte” is a chemical substance or product, for example a biological molecule. It may comprise at least one of the following elements: one or more functional groups (antigens in particular), molecules, particles, macromolecules, DNA, RNA, antibiotics, hormones, toxins, molecules endogenous or exogenous to the matrix under test, cells, bacteria, viruses, mycotoxins, veterinary and/or human medicines, pesticides, hormones, antibodies, etc.

In the context of the present document, a “liquid” is preferably an aqueous liquid or an aqueous liquid preparation, for example blood, milk, urine, saliva, tears, any other physiological liquid, rainwater, swimming pool water, surface water, river water or sewage water. The liquid may be edible and/or intended for use in the food industry. It may comprise a food matrix. Its composition can vary as it progresses through the microfluidic device.

The disclosure can be used in particular in the context of a measurement detection for detecting the presence, and possibly the quantity, of an analyte in a liquid, and/or in the context of measuring the physical and/or chemical parameters of a liquid, for example its viscosity.

In the context of this document, the adjective “transparent” means allowing light to pass through at least in the range 350 to 750 nm.

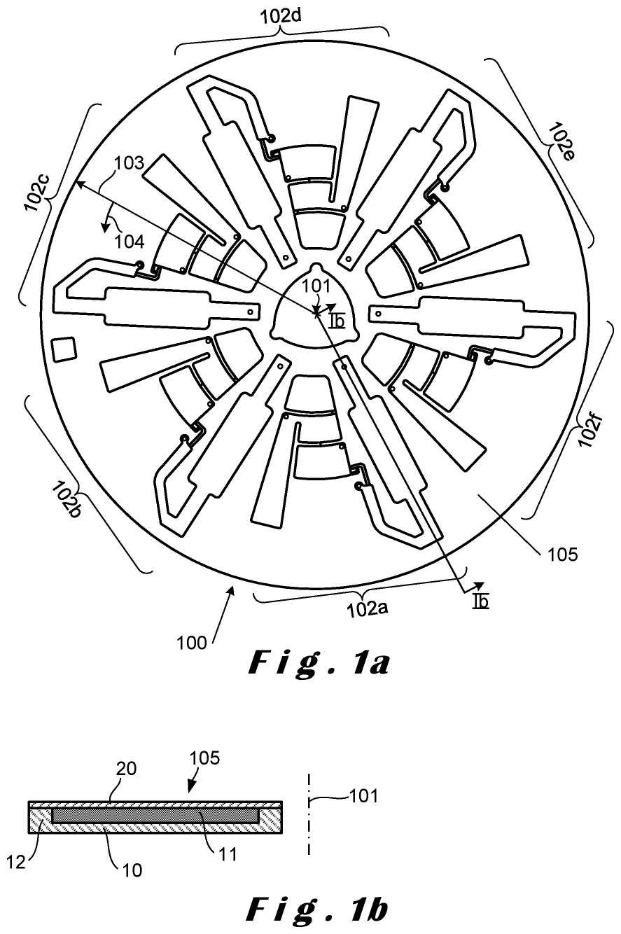

FIG. 1a is a top view of a microfluidic device 100 according to one possible embodiment of the disclosure. The microfluidic device 100 comprises a support 105, preferably circular in shape and arranged to rotate about an axis 101, and a permeable element 200 (visible in particular in FIG. 2). The permeable element 200 is configured so that a liquid can progress through it by capillary action. It is preferably formed from a stick, for example the stick described in WO2019/068806.

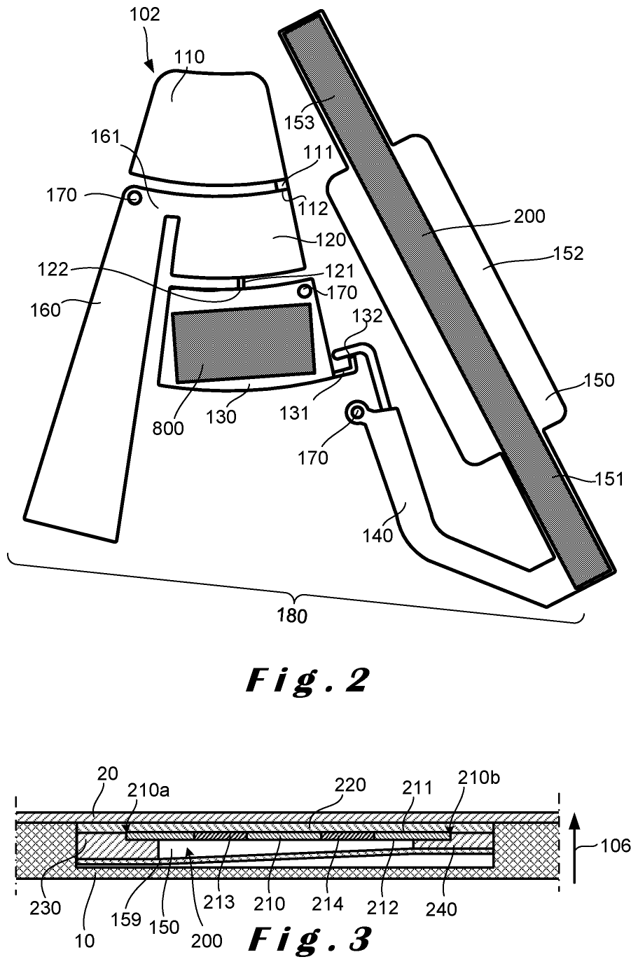

The microfluidic device 100 preferably comprises a plurality of circumferentially distributed microfluidic tracks 102a to 102f, which are generally referred to as 102. The tracks 102 are preferably identical, but could be different while remaining within the scope of the disclosure. FIG. 1a also illustrates a radial direction 103, and a circumferential direction 104, perpendicular to the radial direction 103. The height 106 (visible in FIG. 3) is the direction of the axis 101. The thickness of the components of the permeable element 200, in particular the porous support 210, is measured parallel to the height 106.

FIG. 1b is a cross-sectional view of the support 105 at the level of the line 1b in FIG. 1a. The support 105 preferably comprises a lower portion 10 and an upper portion 20. The lower portion 10 comprises recesses 11 which form the tracks 102, the recesses being separated by projections 12. The upper portion 20 is preferably flat. The upper portion 20 forms a cover over at least one portion of the recesses 11 and is glued to the projections 12. The upper portion 20 is transparent at least in places, preferably throughout. The upper portion 20 may comprise an adhesive on its lower surface, allowing it to adhere to the lower portion 10. The lower portion 10 and the upper portion 20 are preferably different parts attached together. They can be made of different materials. The lower portion 10 is designed to absorb more electromagnetic radiation in the range 700 nm to 100 μm than the upper portion 20. It preferably has a reflectance of less than 10% between 700 nm and 100 μm. The upper portion 20 is preferably located above the lower portion 10.

FIG. 2 shows an enlarged view of one of the tracks 102. Each track 102 comprises a plurality of chambers and passages so as to form an upstream-downstream fluidic path. In one embodiment of the disclosure, each track 102 comprises, from upstream to downstream: an inlet chamber 110, a first passage 111, a volume attachment chamber 120, a second passage 121, a first reagent chamber 130, a third passage 131, a transfer chamber 140 and a detection chamber 150. Each of the inlet chambers 110, of volume attachment chamber 120, of first reagent chamber 130 and of transfer 140 may be referred to as a “preparation chamber”. In addition, each track 102 comprises a collection chamber 160 communicating with the first passage 111 via a collection passage 161. Each track 102 also comprises a plurality of vents 170.

The first passage 111 comprises a first valve 112 preferably having an opening condition which causes it to open from an angular speed V₁₁₂. The second passage 121 comprises a second valve 122 which preferably has an opening condition such that it opens from an angular speed V₁₂₂. The third passage 131 comprises a third valve 132 which preferably has an opening condition such that it opens from an angular speed V₁₃₂. The microfluidic device 100 is preferably designed so that V₁₃₂≥V₁₂₂≥V₁₁₂. This allows to control the duration the liquid spends in the inlet chamber 110, in the volume attachment chamber 120, and in the first reagent chamber 130, by controlling the angular speed of the microfluidic device 100.

The portion of the tracks 102 allowing to prepare the liquid before it enters the permeable element 200 may be referred to as the preparation portion 180. Each track 102 comprises a preparation portion 180 and a detection chamber 150. The preparation portion 180 advances the liquid radially outwards. The speed of the progression is controlled by a first type of fluidic displacement, i.e. by the rotational speed of the microfluidic device 100. The detection chamber 150 causes the liquid to progress radially inwards. The speed of the progression is controlled in particular by a second type of fluidic displacement, i.e. by the capillarity of the permeable element 200. The microfluidic device 100 is preferably at a standstill during the liquid migration in the permeable element 200. However, it is possible, while remaining within the scope of the disclosure, for the rotation of the disc to be used during the movement of the liquid in the permeable element 200, for example in order to slow down this movement.

The inlet chamber 110 allows to introduce a liquid potentially containing an analyte. The volume attachment chamber 120 allows to fix the volume of liquid that will go towards the first reagent chamber 130, with the excess volume going towards the collection chamber 160. The first reagent chamber 130 comprises a first reagent. The transfer chamber 140 is used to bring the liquid to the end of the detection chamber 150 where it is at least partially absorbed by the permeable element 200, which preferably comprises a measuring reagent.

The first reagent may comprise one or more chemical and/or biochemical compounds. The first reagent may be present in a buffer 800, and/or dried on a container and/or on a porous filter, and/or placed on the bottom of the cavity 330 in a liquid or solid state. It may be present on the permeable element 200, upstream of the measuring reagent. In this case, the first reagent chamber 130 is preferably omitted from the track 102. The first reagent is potentially labelled so that it can be detected optically. For example, it may be detectable by fluorescence and/or comprise metal nanoparticles (gold, silver, etc.), polymer nanoparticles (latex, cellulose, etc.) and/or magnetic nanoparticles.

The measuring reagent is designed to react with the first reagent. In a first type of immunological test, the measuring reagent is designed to compete with the analyte and with the first reagent by direct competition of the measuring reagent with the analyte and the first reagent, so as to carry out an immunological test by direct competition between the analyte and the first reagent. For example, the analyte, if present in the liquid, comprises a first antigen, the first reagent comprises a second, labelled antigen, and the measuring reagent comprises an antibody capable of attaching the first and the second antigens. In a second type of immunological test, the first reagent is designed to react with the analyte and with the measuring reagent so as to carry out an immunological test by indirect competition between the analyte and the measuring reagent. For example, the analyte, if present in the liquid, comprises a first antigen, the measuring reagent comprises a second antigen, and the first reagent comprises a labelled antibody capable of attaching the first and the second antigens. In a third type of immunological test, the measuring reagent and the first reagent are designed to react with the analyte so as to carry out a sandwich immunological test in which the analyte is attached by the measuring reagent and labelled by the first reagent.

The detection chamber 150 is radially elongated so that the permeable element 200 is arranged radially. The detection chamber 150 preferably comprises, in succession, a first portion 151, a second portion 152 and a third portion 153. The second portion 152 is circumferentially wider than the first portion 151 and than the third portion 153. An area 213, 214 for reading the porous support 210 of the permeable element 200, as described in the context of this document, is preferably located in the second portion 152.

FIG. 3 is a cross-sectional view of the possible arrangement of the permeable element 200 in the detection chamber 150. FIG. 3 allows to illustrate certain characteristics of the first aspect of the disclosure. The fluid inlet of the permeable element 200 is at its radially external end. The permeable element 200 comprises a porous support 210, preferably made of nitrocellulose, including the measuring reagent. The porous support 210 has a first face 211 and a second face 212 separated by a thickness. It is preferably a membrane. The first face 211 is preferably attached, for example glued, to a structural support 220, which is transparent at least in places and preferably throughout. In a non-illustrated embodiment of the first aspect of the disclosure, the first face 211 is joined directly to the upper portion 20. Preferably, there is at least one free space between the lower portion 10 and the permeable element 200.

The porous support 210 is preferably made of nitrocellulose. It has a thickness between 100 μm and 300 μm. It is preferably glued to the structural support 220 along its entire length and its entire width.

The porous support 210 comprises at least one reading area 213, 214. In the context of this document, a reading area 213, 214 is a portion of the porous support 210 configured so that a parameter can be measured there. For example, it may comprise the measuring reagent. The upper portion 20 is transparent at least above the reading area 213, 214.

The porous support 210 may comprise, for example, a first reading area 213 for reacting with a measuring reagent, and a second reading area 214, preferably separate from the first 213, for reacting with another measuring reagent. It may comprise more than two reading areas, for example three or four. In the context of this document, a “reading area” is an area of the permeable element 200 designed to be read, preferably optically. It can be, for example, the first, the second or all of the reading areas.

The structural support 220, which is optional, is preferably impermeable. It is preferably made of polymer material. For example, it has a thickness between 100 μm and 800 μm.

If the structural support 220 is present, it is secured on the one hand to the upper portion 20 and on the other with the porous support 210, above the reading area 213, 214, and the structural support 220 and the upper portion 20 are transparent above the reading area 213, 214.

The porous support 210 has two opposite ends. The first end 210a is radially external. It is closer to the transfer chamber 140 than the second end 210. The second end 210b is radially internal.

The permeable element 200 preferably comprises a first porous element 230 attached to the structural support 220. The first element 230 is in contact with a first end 210a of the porous support 210. It projects radially outwards and downwards beyond the first end 210a. The first element 230 acts as a reservoir allowing the permeable element 200 to be fed progressively, depending on its absorption by capillary action. It can have a filtration function. It can comprise several portions, for example one of its portions could comprise a conjugated reagent.

The permeable element 200 preferably comprises a second porous element 240 attached to the structural support 220. The second porous element 240 allows to absorb the liquid at the end of the permeable element 200. It allows the flow of liquid to be maintained on the porous support 210 once it has been completely soaked.

The microfluidic device 100 preferably comprises a contrast enhancement element 159 located, in the detection chamber 150 and, at least below the reading area 213, 214, between the lower portion 10 and the porous support 20. The contrast enhancement element 159 is arranged to create a contrast between the reading area 213, 214 and the background of the image when taking an image of the reading area 213, 214 through the structural support 220 and the upper portion 20. It preferably has a reflectance of at least 20% at a wavelength between 450 and 600 nm. It is preferably attached to the permeable element 200 via the first element 230 and second element 240. It can be a leaf.

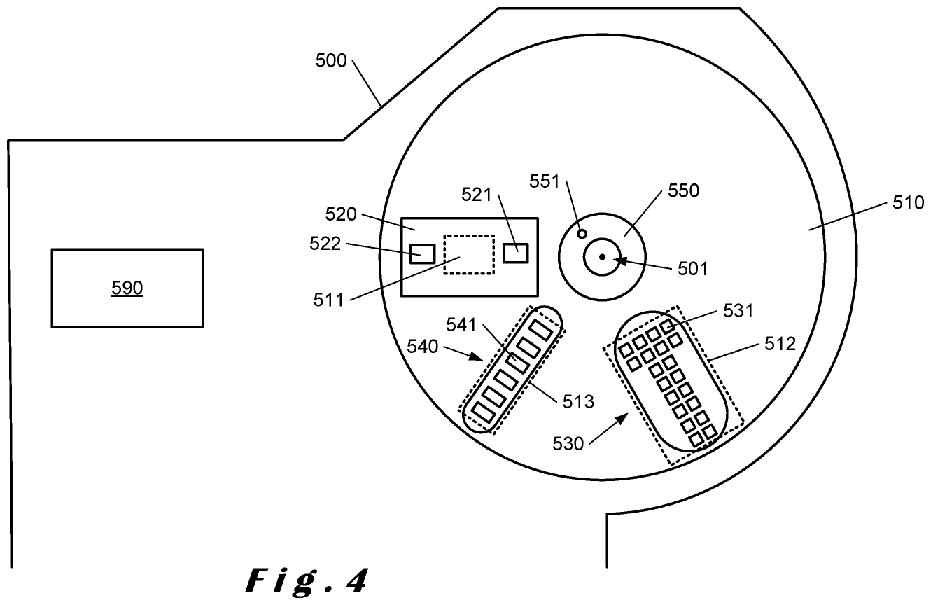

FIG. 4 is a very schematic view of a control device 500 according to one embodiment of the disclosure. It allows to show the circumferential and radial positions of certain elements of the control device 500. FIGS. 4 to 7 allow to illustrate certain characteristics of the first and of the second aspects of the disclosure.

The control device 500 comprises a device site 510 for positioning the microfluidic device 100. The microfluidic device 100 is preferably placed at device site 510 with the upper portion 20 above the lower portion 10. The device site 510 is arranged so as to rotate the microfluidic device 100 about an axis 501 of the control device 500, which is coincident with the axis 101 of the microfluidic device 100. The device site 510 comprises a detection area 511 and a heating area 512 circumferentially offset from each other. Thus, at least one portion of the microfluidic device 100, for example the detection chamber 150, can be moved between the detection area 511 and the heating area 512 by rotation about the axis 501.

The control device 500 comprises a detection module 520 comprising a detector 521 designed to detect an electromagnetic radiation coming from the detection area 511, and in particular from the reading area 213, 214 when it is in the detection area 511. The detector 521 preferably comprises a camera and/or a photographic sensor. The detection module 520 provides detection information, which may comprise images and/or information about the position of the liquid.

The control device 500 is preferably configured so that the detector 521 is capable of checking at least one of the following points:
whether the liquid is actually present in each of the tracks 102,
the position of the liquid in the track 102,
the position of the permeable element 200 in the detection chamber 150,
the progress of the liquid through the permeable element 200,
the modification of the reading area 213, 214 of the permeable element 200 due to the absence or to the presence of the analyte in the liquid introduced into the track 102.

The detection module 520 may also comprise an illumination element 522, for example a lamp, provided to illuminate the detection area 511 in a wavelength range suitable for observing, by the detector 521, a modification in the permeable element 200, for example linked to a detection of the analyte. The illumination wavelength range may be between 350 and 750 nm, for example. It is possible that the wavelength range emitted by the illumination element 522 is identical to that perceived by the detector 521, or is different from that perceived by the detector 521 (in fluorescence for example).

The control device 500 comprises a heating module 530 arranged to heat the heating area 512. The heating module 530 is preferably offset circumferentially from the detection module 520. The heating module 530 preferably allows to provide an electromagnetic heating, preferably by radiation or induction. An infrared radiation heating, for example at a wavelength between 700 nm and 100 μm, can be used. It is also possible to use an electromagnetic induction heating, for example by incorporating metal balls in the tray 515 (visible in FIG. 5) or in the lower portion 10.

The heating module 530 preferably comprises a plurality of heating elements 531 located at different radial distances from the axis 501 and/or offset circumferentially. They can be arranged in a T-shape as shown in FIG. 4, but could also be arranged in rectangles, crosses or in any other way within the scope of the present disclosure. An arrangement of the heating elements 531 where there are more of them above the inlet chamber 110 is preferred because the liquid, which is potentially cold when it is introduced (particularly if it is milk), is brought to a reference temperature in the inlet chamber 110, which requires a high heating power. Then, during the steps in the other chambers 120, 130, 140, 150, 160, the temperature can be modified or maintained, but the temperature increase is less than in the inlet chamber 110.

The heating elements 531 can be controlled independently and/or in groups. Each radial line (or each circumferential line) of heating elements 531 may form a group. The distribution of the heating elements 531 into groups can also be controlled via the control unit 590. Each of the chambers 110, 120, 130, 140, 150, 160 may correspond to a group of heating elements 531. A heating element 531 can be in several groups. For example, a heating element 531 may be in a first group corresponding to the first reagent chamber 130 and a second group corresponding to the detection chamber 150. The heating elements 531 can be infra-red diodes, for example.

The control device 500 is preferably designed so that different areas of the microfluidic device 100 can be heated to different temperatures. For example, the first reagent chamber 130 can be heated to a first temperature and the detection chamber 150 can be heated to a second temperature different from the first temperature.

The control device 500 preferably comprises a measurement module 540 arranged to measure a parameter, preferably a temperature, of the microfluidic device. The device site 510 comprises, for example, a measurement area 513 circumferentially offset from the detection area 511 and from the heating area 512, and the measurement module 540 being arranged to measure the parameter on the measurement area 513. The measurement module 540 is preferably offset circumferentially from the detection module 520 and from the heating module 530. The temperature measurement is preferably carried out by infra-red emission measurement, for example between 700 nm and 100 μm wavelength. The measurement module 540 provides temperature information, which may comprise a temperature as a function of a position in the measurement area 513. The control device 500, preferably the control unit 590, can then decide to heat a position further, via the heating module 530, if the temperature measured there is lower than a reference temperature. Similarly, if the temperature on a track 102 is measured too low, the control device 500 can decide to bring this track 102 into the heating area 512 to be heated.

The measurement module 540 preferably comprises a plurality of measurement elements 541 located at different radial distances from the axis 501 and/or offset circumferentially. They can be arranged in a line as shown in FIG. 4, but could also be arranged in a T, a rectangle, a cross or in any other way within the scope of the present disclosure. They can be controlled independently and/or in groups. Each radial line (or each circumferential line) of measuring element 541 may form a group. The division of the measuring elements 541 into groups can also be controlled via the control unit 590. Each of the chambers 110, 120, 130, 140, 150, 160 can correspond to a group of measuring elements 541. A measuring element 541 can be in several groups. For example, it is possible for a measuring element 541 to be in a first group which corresponds to the first reagent chamber 130 and, potentially after rotation, to a second group which corresponds to the detection chamber 150. The measuring elements 541 are, for example, infra-red detectors.

Although the microfluidic device 100 rotates so that some of its elements move from one area to another, the microfluidic device 100 is preferably at a standstill during a detection (preferably optical) by the detection module 520, a heating by the heating module 530 and a measurement (preferably temperature) by the measurement module 540.

The control device 500 preferably comprises a control unit 590 configured for at least one of the following operations:
receive, and preferably analyse, detection information, for example images, from the detector 521,
generate an error message (intended, for example, to be displayed on a screen of the control device 500) if the detection information does not correspond to an expected reference situation (for example, if the liquid is supposed to be in one of the chambers 110, 120, 130, 140, 150, 160 but is not there on the images),
control the illumination element 522,
receive, and preferably analyse, temperature information from the measurement module 540,
control the heating module 530, preferably as a function of the temperature measured by the measurement module 540 and/or of the position of the liquid detected by the detector 521,
control the heating elements 531 in groups and/or independently of each other,
control the measuring elements 541 in groups and/or independently of each other,
control the orientation of the microfluidic device 100 (in particular passing the microfluidic tracks 102a-102f between the detection area 511, the heating area 512, and preferably the measurement area 513), potentially as a function of the temperature measured by the measurement module 540 and/or the position of the liquid detected via the detector 521,
control the speed of rotation of the microfluidic device 100, which may allow the first valve 112, then the second valve 122, then the third valve 132 to be opened successively, potentially as a function of the temperature measured by the measurement module 540 and/or the position of the liquid detected via the detector 521.
   The control unit 590 is able to sequence all the operations in a harmonious way.

Me control unit 590 may comprise a processor, a central processing unit (CPU), a digital signal processor 30 (DSP), an application specific integrated circuit (ASIC), a field programmable gate array (FPGA), or the like, or any combination thereof, and may comprise discrete digital or analogue circuit elements or electronic components, or combinations thereof. It is preferably configured to run one or more computer programs allowing any method for using the various aspects of the present disclosure to be implemented.

The control device 500 can comprise a liquid introduction module 550, or filling module, comprising at least one opening 551 through which the liquid can be introduced into the inlet chamber 110. Alternatively, the liquid may be introduced into the inlet chamber 110 before being placed in the device site 510.

FIG. 5 is a highly schematic vertical view of a detection system 1 according to one embodiment of the disclosure. The detection system 1 comprises the microfluidic device 100 and the control device 500. The microfluidic device 100 is designed to be used only once and then discarded, and the control device 500 is designed to be reused. The control device 500 comprises, for example, a hub 515 located in a drawer so that the microfluidic device 100 can be mechanically coupled to the hub 515 when the drawer is open. When the drawer is closed, the hub 515 assumes a position such that the microfluidic device 100 is at the device site 510. The hub 515 can be significantly narrower than shown in FIG. 5. With regard to the height of the elements of the control device 500, the device site 510 is preferably a space located lower than the modules 520, 530, 540, 550, as illustrated in FIG. 5.

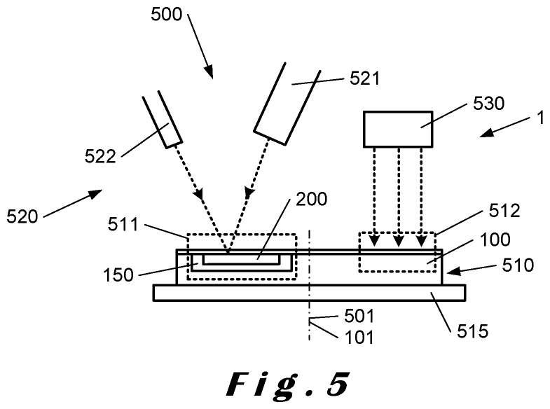

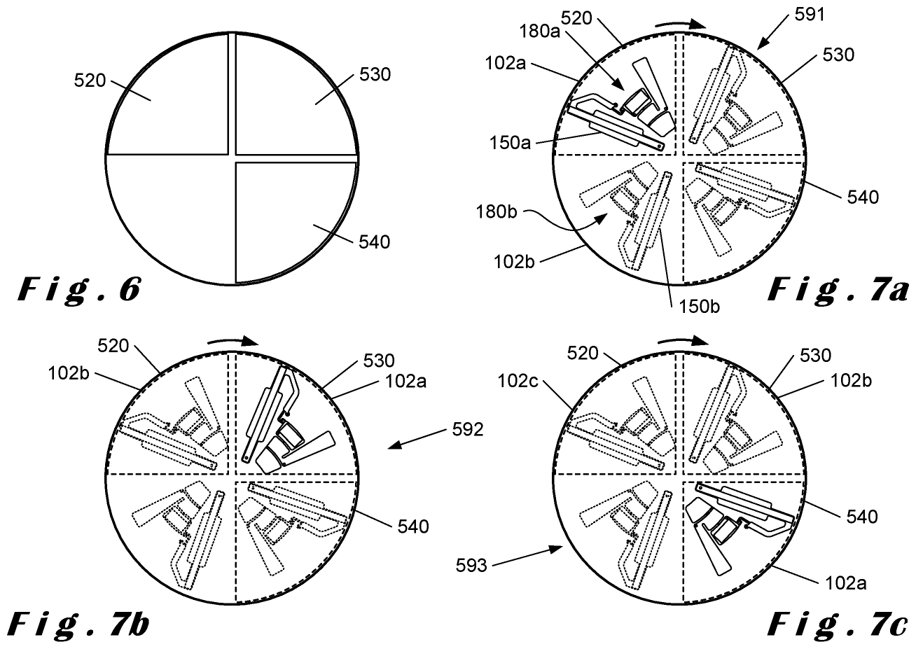

FIG. 6 is a top view allowing to illustrate a possible arrangement of the modules 520, 530, 540 of the control device 500, different from the arrangement in FIG. 4. Any other arrangement of the modules is possible, and one or more modules could be present several times while remaining within the scope of the present disclosure. FIGS. 7a, 7b and 7c illustrate different possible orientations of the microfluidic device 100, and in particular its first 102a, second 102b and third 102c microfluidic tracks, relative to the positions of the modules 520, 530 and 540 shown in FIG. 6. The microfluidic device 100 moves from one orientation to the other by a rotation controlled by the control unit 590, preferably by rotation of the hub 515.

FIG. 7a illustrates a first orientation 591 of the microfluidic device 100, in which at least the area 213, 214 for reading the permeable element 200 of the detection chamber 150a of the first track 102a is in the detection area 511 and is detectable by the detection module 520. Preferably, the preparation portion 180a of the first track 102a is also, at least in part, in the detection area 511.

FIG. 7b illustrates a second orientation 592 of the microfluidic device 100 obtained by rotation relative to FIG. 7a. In the second orientation 592, at least the area 213, 214 for reading the permeable element 200 of the detection chamber 150a of the first track 102a is in the heating area 512 and can be heated by the heating module 530. Preferably, the preparation portion 180a of the first track 102a is also, at least in part, in the heating area 512. In particular, at least one of the following portions may be in the heating area 512: the inlet chamber 110, and the first reagent chamber 130. Heating the liquid in the inlet chamber 110 allows to even out the temperature of the liquid samples introduced. Heating the liquid in the first reagent chamber 130 allows to facilitate the incubation of the analyte with the first reagent 130.

In the second orientation 592, at least the area 213, 214 for reading the permeable element 200 of the detection chamber 150b of the second track 102b is in the detection area 511 and is detectable by the detection module 520. Preferably, the preparation portion 180b of the second track 102b is also, at least in part, in the detection area 511.

FIG. 7c illustrates a third orientation 593 of the microfluidic device 100 obtained by rotation with respect to FIG. 7b. In the third orientation 593, at least the area 213, 214 for reading the permeable element 200 of the detection chamber 150a of the first track 102a is in the measurement area 513 and its temperature can be measured by the measurement module 540. Preferably, the preparation portion 180a of the first track 102a is also, at least in part, in the measurement area 513. In particular, at least one of the following portions may be in the measurement area 513: the inlet chamber 110, the volume attachment chamber 120, and the first reagent chamber 130. By measuring the temperature, the heating carried out by the heating module can be adapted to obtain a specific temperature in one of the chambers 110, 120, 130, 140, 150.

Preferably, in the third orientation 593, at least the area 213, 214 for reading the permeable element 200 of the detection chamber 150b of the second track 102b is in the heating area 512 and can be heated by the heating module 530. Preferably, the preparation portion 180b of the second track 102b is also, at least in part, in the heating area 512.

Preferably, in the third orientation 593, at least the area 213, 214 for reading the permeable element 200 of the detection chamber 150c of the third track 102c is in the detection area 511 and is detectable by the detection module 520. Preferably, the preparation portion 180c of the third track 102c is also, at least in part, in the detection area 511.

Although FIGS. 7a, 7b and 7c show only three orientations, it is possible that there may be more in the context of the present disclosure. In addition, any orientation intermediate between the three illustrated orientations is possible within the scope of the present disclosure, for example to target one of the chambers.

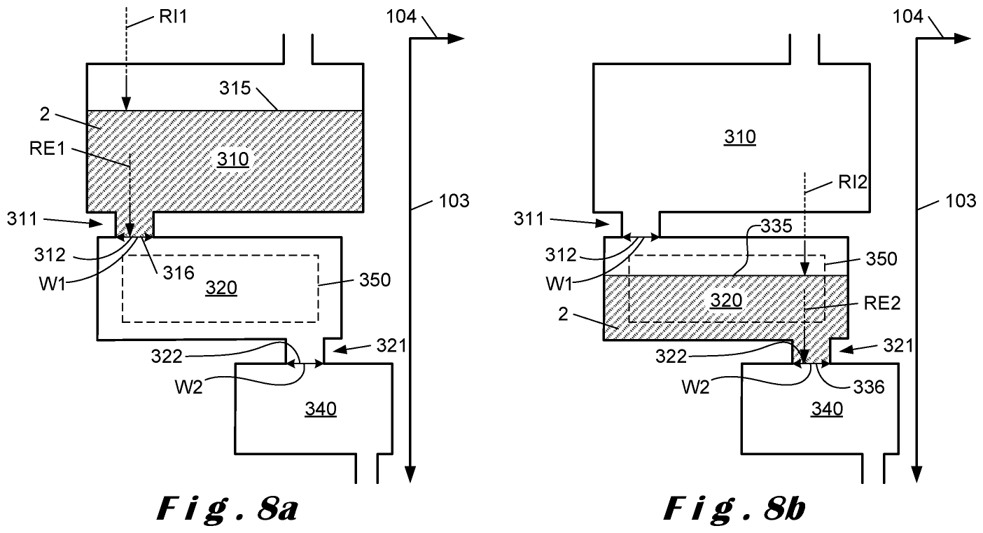

FIGS. 8 to 12 allow to illustrate certain characteristics of the third aspect of the disclosure. A microfluidic device 100 for handling a volume of liquid 2 according to the third aspect of the disclosure may have any of the characteristics described in this document. An assembly according to the third aspect of the disclosure comprises, in addition to the microfluidic device 100, a volume of liquid. The volume of liquid potentially comprises an analyte.

FIGS. 8a and 8b illustrate a possible arrangement of a portion of a microfluidic device according to the third aspect of the disclosure. The microfluidic device preferably comprises, from upstream to downstream, a first upstream location 310, an upstream passage 311 which terminates in an upstream valve 312, a first intermediate location 320 comprising a first function area 350, a downstream passage 321 which terminates in a downstream valve 322, and a downstream location 340. The downstream valve 322 is preferably further from the axis 101 than the upstream valve 312.

The upstream valve 312 has an opening condition (referred to as the first opening condition) which is satisfied when a pressure obtained by centrifugal force exerted by the liquid on the upstream valve 312 is greater than a capillary pressure exerted by the upstream valve 312 on the liquid. This occurs from a first angular speed V1 because the pressure obtained by centrifugal force increases with the angular speed. The downstream valve 322 has an opening condition (referred to as the second opening condition) which is satisfied when a pressure obtained by centrifugal force exerted by the liquid on the downstream valve 322 is greater than a capillary pressure exerted by the downstream valve 322 on the liquid, which occurs from a second angular speed V2. The microfluidic device is such that V2 is greater than or equal to V1 in order to be able to retain the volume of liquid, at least in part, in the intermediate location 320 for a first duration. This allows a first function, intended to be carried out in the first intermediate location 320, to be implemented on the liquid during the first duration. The first function can also be referred to as the first step, or intermediate step.

The first upstream location 310 can be configured for a second function which requires the liquid to be held there for a second duration. The second function can also be referred to as the second step, or the upstream step. The second function is therefore carried out before the first function on an upstream-downstream path. The first and the second functions are preferably different. They can be, for example: a detection, an attachment of the volume of liquid, a heat treatment, a chemical treatment, for example an incubation with a reagent. In one embodiment, the microfluidic device comprises a permeable element 200 immobilising a measuring reagent (for example a permeable element as described in relation to the first and/or second aspects of the disclosure), and the first function is an incubation with a first reagent present in the first intermediate location 320. A heater may also be involved in the first and/or the second function, for example as described in relation to the second aspect of the present disclosure.

The locations are preferably situated in chambers of a microfluidic device 100. The third aspect of the disclosure can be implemented in several ways on a track 102 as described in particular in relation to FIG. 2. In a first implementation of the third aspect of the disclosure, the first upstream location 310 is in the inlet chamber 110, the first intermediate location 320 is in the volume attachment chamber 120, the downstream location 340 is in the first reagent chamber 130, the upstream valve 312 is the first valve 112, and the downstream valve 322 is the second valve 122. In a second implementation of the third aspect of the disclosure (partially illustrated in FIG. 11), the first upstream location 310 is in the volume attachment chamber 120, the first intermediate location 320 is in the first reagent chamber 130, the downstream location 340 is in the transfer chamber 140, the upstream valve 312 is the second valve 122, and the downstream valve 322 is the third valve 132. The volume of liquid 2 is preferably that retained by the volume attachment chamber 120.

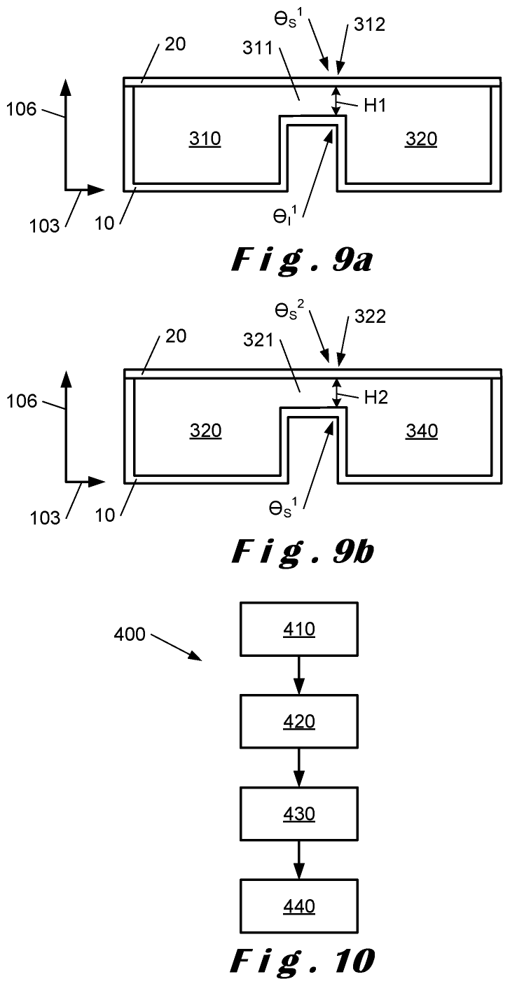

In FIG. 8a, the volume of liquid 2 is blocked by the upstream valve 312. In FIG. 8b, it is blocked by the downstream valve 322. FIG. 9a is a cross-sectional view of the upstream passage 311, and FIG. 9b is a cross-sectional view at the level of the downstream passage 321. FIGS. 8a, 8b, 9a, 9b allow to illustrate parameters shown in the table below, with a preferred range of values.

| Parameter | Description | Values | Units |
|---|---|---|---|
| R_{I1} | Radial distance between the axis 101 and a | [10-150] | mm |
| | radially internal wall 315 of the volume of liquid | | |
| | 2 blocked by the upstream valve 312 | | |
| R_{E1} | Radial distance between the axis 101 and the | [10-150] | mm |
| | upstream valve 312 | | |
| θ_{S}¹ | Contact angle between the liquid and the upper | [0-180] | Deg |
| | portion 20 of the microfluidic device at the site | | |
| | of the upstream valve 312 | | |
| θ_{I}¹ | Contact angle between the liquid and the lower | [0-180] | Deg |
| | portion 10 of the microfluidic device at the site | | |
| | of the upstream valve 312 | | |
| H₁ | Upstream valve height 312 | [100-1000] | μm |
| W₁ | Upstream valve width 312 | [100-1000] | μm |
| R_{I2} | Radial distance between the axis 101 and a | [10-150] | mm |
| | radially internal wall 315 of the volume of liquid | | |
| | 2 blocked by the downstream valve 322 | | |
| R_{E2} | Radial distance between the axis 101 and the | [10-150] | mm |
| | downstream valve 322 | | |
| θ_{S}² | Contact angle between the liquid and the upper | [0-180] | Deg |
| | portion 20 of the microfluidic device at the site | | |
| | of the downstream valve 322 | | |
| θ_{I}² | Contact angle between the liquid and the lower | [0-180] | Deg |
| | portion 10 of the microfluidic device at the site | | |
| | of the downstream valve 322 | | |
| H₂ | Height of downstream valve 322 | [100-1000] | μm |
| W₂ | Width of the downstream valve 322 | [100-1000] | μm |

θ_{I1,2} is the contact angle with the lower wall and the sides, which are formed by the lower portion 10. θ_{S1}+θ_{I1}>90° and θ_{S2}+θ_{I2}>90°. In one embodiment of the disclosure, the liquid is milk, the lower portion 10 is made of PMMA and the upper portion 20 is an acrylate-based adhesive film. In this case, θ_{I1}=θ_{I2}≈65° and θ_{S1}=θ_{S2}≈115°.

In one embodiment, the first opening condition is

$$\frac{1}{2} ρ {V}_{1}^{2} ( {R}_{E 1}^{2} - {R}_{I 1}^{2} ) > σ ( - \frac{cos ( {θ}_{I 1} + \frac{π}{2} ) + cos ( {θ}_{S 1} )}{{H}_{1}} - \frac{2 cos ( {θ}_{I 1} + \frac{π}{2} )}{{W}_{1}} )$$

and the second opening condition is

$$\frac{1}{2} ρ {V}_{2}^{2} ( {R}_{E 2}^{2} - {R}_{I 2}^{2} ) > σ ( - \frac{cos ( {θ}_{I 2} + \frac{π}{2} ) + cos ( {θ}_{S 2} )}{{H}_{2}} - \frac{2 cos ( {θ}_{I 2} + \frac{π}{2} )}{{W}_{2}} )$$

ρ is the density of the liquid and σ is the surface tension of the liquid.

FIG. 10 shows the various steps of a method according to the third aspect of the disclosure. The method comprises the following steps. It is preferable for one step to be completed before the next begins. The volume of liquid 2 is positioned 410 upstream of the upstream valve 312 so as to be blocked by the upstream valve 312. The microfluidic device is then accelerated 420 so that its angular speed exceeds V1, and the volume of liquid 2 passes through the upstream valve 312. It arrives at the intermediate location 320 where it is stored 430 for the first duration. The first duration is preferably less than the time between 420 and 440. It is blocked by the downstream valve 322. The microfluidic device is then accelerated 440 so that its angular speed exceeds V2, and the volume of liquid 2 passes through the downstream valve 322. The rotation of the microfluidic device is preferably controlled by a computer program running on the control unit 590.

FIG. 11 is a top view of a valve 322 in one embodiment of the disclosure. This embodiment is particularly suitable for the downstream valve 322, but could also be used for the upstream valve 312. The channel 321 has an inlet 321a which opens into the first intermediate location 320 and outlet 321b which forms the downstream valve 322 and opens into the downstream location 340. Preferably, the outlet 321b is radially more internal than the inlet 321a.

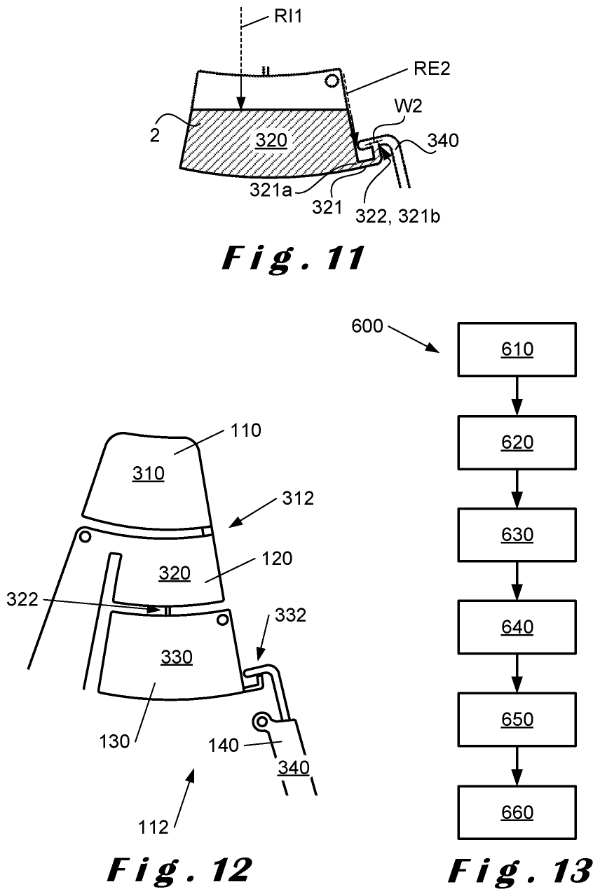

FIG. 12 is a top view of a portion of a microfluidic device according to one embodiment of the third aspect of the disclosure. It allows to illustrate an embodiment of the third aspect of the disclosure with a second intermediate location 330 and an additional valve 332. The second intermediate location 330 is configured for a third function which requires the liquid to be held there for a third duration. The third function can also be referred to as the third step, or downstream step. The additional valve 332 has a third opening condition which is satisfied when a pressure obtained by centrifugal force exerted by the liquid on the additional valve 332 is greater than a capillary pressure exerted by the additional valve 332 on the liquid, which occurs from a third angular speed V3, the third angular speed V3 being greater than or equal to the second angular speed V2.

FIG. 12 also allows to illustrate another implementation of the third aspect of the disclosure in relation to the microfluidic track 112. It illustrates a possible arrangement of the locations 310, 320, 330, 340 with respect to the chambers 110, 120, 130, 140 of the microfluidic track 102: the first upstream location 310 is in the inlet chamber 110, the first intermediate location 320 is in the volume attachment chamber 120, the second intermediate location 330 is in the first reagent chamber 130, the downstream location 340 is in the transfer chamber 140, the upstream valve 312 is the first valve 112, the downstream valve 322 is the second valve 122, and the additional valve 332 is the third valve 132. The first function comprises an attachment of the volume of the liquid, the second function comprises an introduction of liquid and the third function comprises an incubation with the first reagent.

FIG. 13 illustrates a method 600 combining the three aspects of the disclosure. The person skilled in the art will understand that the steps, although described as successive, can take place partly in parallel. In step 610, the microfluidic device 100 is manufactured. Each track 102 includes a permeable element 200 and a first reagent. The permeable elements 200 may be identical or different. The first reagent in each track 102 corresponds to the reagent for measuring the permeable element 200 in that track 102.

In step 620, liquid comprising an analyte is introduced into the inlet chambers 110 of the various tracks 102 of the microfluidic device 100. This can be the same liquid for all the tracks or different liquids. For example, if milk is being tested, different analytes from the same milk can be tested in parallel using different first reagents and permeable elements 200 and/or multiple milks can be tested against the same analyte. When it is introduced, the liquid may be at a low temperature, for example if it has been refrigerated. The inlet chamber 110 of each track 102 then passes from the heating area 512 to the measurement area 513 until the temperature of the liquid there reaches a first threshold. In addition, the inlet chamber 110 of each track 102 passes through the detection area 511 to check the actual presence of a liquid. If no liquid is present, the control unit 590 can send an alert.

When the temperature of the liquid has reached the first threshold, the microfluidic device 100 is accelerated beyond the speed V₁₁₂ in order to open the first valve 112 and the liquid passes 630 into the volume attachment chamber 120. A volume of liquid is kept in the volume attachment chamber 120 and the surplus passes into the collection chamber 160. The volume attachment chamber 120 of each track 102 passes through the detection area 511 to check the actual presence of a liquid. If no liquid is present, the control unit 590 can send an alert.

When the liquid has been detected in each of the volume attachment chambers 120, the microfluidic device 100 is accelerated beyond the speed V₁₂₂ to open the second valve 122 and the liquid passes 640 into the first reagent chamber 130. The first reagent chamber 130 of each track 102 then moves from the heating area 512 to the measurement area 513 until the temperature of the liquid there reaches a second threshold. In addition, the first reagent chamber 130 of each track 102 passes through the detection area 511 to check the actual presence of a liquid. If no liquid is present, the control unit 590 can send an alert. When the temperature of the liquid has reached the second threshold, the liquid is left in the first reagent chamber 130 for a duration sufficient for an incubation of the analyte with the first reagent. This duration is an example of the second duration, or third duration, mentioned in the description of the third aspect of the disclosure.

The microfluidic device 100 is then accelerated beyond the velocity V₁₃₂ to open the third valve 132 and the liquid passes 650 into the transfer chamber 140. Its temperature is controlled by passing through the measurement area 513 and possibly increased by passing through the heating area 512.

The liquid then arrives 660 in the detection chamber 150, at the radially external end of the permeable element 200. The detection chamber 150 of each track 102 then moves from the heating area 512 to the measurement area 513 until the temperature of the liquid and/or the permeable element 200 reaches a third threshold. In addition, the detection chamber 150 of each track 102 passes through the detection area 511 to check the actual presence of a liquid and its progress through the permeable element 200.

A portion of the liquid is preferentially absorbed by the first element 230 and progresses into the porous support 210 radially inwards. When the liquid reaches the first reading area 213, it can react with the first measuring reagent, and when it reaches the second reading area 214, it can react with the second measuring reagent. These reactions cause a change in the read areas 213, 214 which is detectable by the detector 521 when the read areas 213, 214 pass into the detection area 511. This detection is particularly effective when the permeable element 200 is attached, without any free space, to the upper portion 20 of the microfluidic device 100.

At any time, the control unit can send an alert if an unexpected event occurs, for example if one of the temperature thresholds cannot be reached on one of the tracks.

In other words, according to a second aspect, the disclosure relates to a control device 500 comprising a device site 510 provided for placing a microfluidic device 100 and rotating the microfluidic device 100 about an axis 501, and a plurality of modules 520, 530, 540 distributed circumferentially, so that a track of the microfluidic device 100 passes from one module to another by rotating the microfluidic device 100 about the axis 501.

The present disclosure has been described above in connection with specific embodiments, which are illustrative and should not be considered limiting. In a general manner, the present disclosure is not limited to the examples illustrated and/or described above. The use of the verbs “comprise”, “include”, or any other variant, as well as their conjugations, can in no way exclude the presence of elements other than those mentioned. The use of the indefinite article “a”, “an”, or the definite article “the”, to introduce an element does not exclude the presence of a plurality of these elements. The reference numbers in the claims do not limit their scope.

1. A control device comprising:
a device site provided for placing a microfluidic device and rotating the microfluidic device about an axis, and comprising:
a detection area, and
a heating area;
a detection module comprising a detector designed to detect an electromagnetic radiation coming from the detection area; and
a heating module arranged to heat the heating area;
wherein the detection area being offset circumferentially from the heating area, so that at least one portion of the microfluidic device, for example a chamber, can be moved between the detection area and the heating area by rotation about the axis; and
wherein the heating module comprises a plurality of heating elements located at different radial distances from the axis.

2. The control device as claimed in claim 1, wherein at least two of the heating elements are circumferentially offset from each other.

3. The control device according to claim 2, comprising a control unit configured to control the heating elements in groups and/or independently of one another.

4. The control device according to claim 1, wherein the heating module allows an electromagnetic heating, preferably by radiation or induction.

5. The control device according to claim 1, wherein the device site comprises a measurement area, the control device comprising a measurement module arranged to measure a parameter on the measurement area.

6. The control device according to claim 5, wherein the measurement area is offset circumferentially from the detection area and from the heating area.

7. The control device according to claim 5, wherein the parameter is a temperature.

8. The control device according to claim 7, arranged to control, at least in part, the heating module and/or a rotation of the microfluidic device as a function of the temperature measured by the measurement module.

9. The control device according to claim 5, wherein the measuring module comprises a plurality of measuring elements located at different radial distances from the axis.

10. A detection system comprising a control device according to claim 1, and a microfluidic device located at the device site and comprising a first microfluidic track; wherein the detection area encompasses at least one portion of the first microfluidic track when the microfluidic device is oriented in a first orientation; and wherein the heating area encompasses at least one portion of the first microfluidic track when the microfluidic device is oriented in a second orientation.

11. The detection system according to claim 10, wherein the microfluidic device comprises a second microfluidic track, wherein the detection area encompasses at least one portion of the second microfluidic track when the microfluidic device is oriented in the second orientation.

12. The detection system according to claim 10, wherein a measurement area encompasses at least one portion of the first microfluidic track when the microfluidic device is oriented in a third orientation.

13. A method for using a detection system according to claim 10, wherein at least one portion of the first microfluidic track:
is in the heating area and is heated by the heating module,
passes, by rotation of the microfluidic device from the heating area to the detection area, and
is observed by the detector.

14. The method of claim 13, wherein at least one portion of the first microfluidic track is in the heating area and is heated by the heating module while at least one portion of a second microfluidic track is in the detection area and is observed by the detector.

15. A computer program comprising instructions which drives the detection system according to claim 10, and comprising a control unit, to:
position at least one portion of the first microfluidic track, in the heating area;
heat, by the heating module, the at least one portion of the first microfluidic track;
rotate the microfluidic device so as to position the at least one portion of the first microfluidic track in the detection area; and
observe, by the detector, the at least one portion of the first microfluidic track.
